(19) United States
(12) Patent Application Publication
(10) Pub. No.: US 2018/0129208 A1
(43) Pub. Date: May 10, 2018

(54) METHOD FOR FLIGHT CONTROL BY HOW A DEVICE IS THROWN

(71) Applicant: Digital Aerolus, Inc., Shawnee, KS (US)

(72) Inventors: Thomas D. Williams, Shutesbury, MA (US); Ian J. McEwan, Pasadena, CA (US); Jeffery J. Alholm, Kansas City, MO (US)

(73) Assignee: Digital Aerolus, Inc., Shawnee, KS (US)

(21) Appl. No.: 15/807,191

(22) Filed: Nov. 8, 2017

Related U.S. Application Data
(60) Provisional application No. 62/419,321, filed on Nov. 8, 2016.

(51) Int. Cl. G05D 1/00; B64C 39/02; G08G 5/04

(52) U.S. Cl. CPC G05D 1/0088; B64C 39/024; B64C 2201/024; B64C 2201/108; B64C 2201/145; G08G 5/045

(57) ABSTRACT

An autonomous or semi-autonomous device or vehicle, such as a drone, and method for controlling the same, the method including sensing a physical manipulation or an aspect of a physical manipulation of the autonomous or semi-autonomous device or vehicle, selecting an action and/or modifying an aspect of the action according to the sensed physical manipulation or physical manipulation aspect, and instructing the autonomous or semi-autonomous device or vehicle to perform the action.

### RELATED APPLICATIONS

This regular utility non-provisional patent application claims priority benefit with regard to all common subject matter of earlier filed U.S. Provisional Patent Application titled “METHOD FOR FLIGHT CONTROL BY HOW A DEVICE IS THROWN”, Ser. No. 62/419,321, filed on Nov. 8, 2016, which is hereby incorporated by reference in its entirety into the present application.

### BACKGROUND

Handheld drones, also known as personal drones, remote control drones, and quadcopters, are often used for sport flying, producing aerial images and video recordings, delivering and retrieving objects, and other tasks. However, a drone's capability is often limited by its control and input system and/or a user's ability to operate it. For example, drones can perform complex maneuvers that are not easily translated to electronic joysticks, levers, and direction pads. Handheld controllers are often unwieldy and typically include a separate input for each action. Smartphones, tablets, and other handheld computing devices have been used to consolidate several inputs onto a single touchscreen, but graphical user interfaces (GUIs) lack tactile feedback and are often less intuitive than their analog counterparts. Furthermore, some drone operators such as missing persons in rescue operations may not be in a condition to manipulate a drone via conventional inputs.

### SUMMARY

Embodiments of the present invention solve the above-described and other problems and limitations by providing an improved autonomous or semi-autonomous device and method for controlling the same. More particularly, the invention provides a drone having a more intuitive and more adaptable control system and a method for controlling the same. The present invention encompasses other autonomous or semi-autonomous devices or vehicles such as robots, crawling devices, throwable devices, driving devices, digging devices, climbing devices, floating devices, submersible devices, and space-borne devices.

An embodiment of the invention is a method of controlling a drone. First, a camera or a sensor of the drone may sense a physical manipulation or an aspect of a physical manipulation of the drone. For example, the physical manipulation may be a grasp/grip, hold, shake, move, throw, toss, push, roll, or any other suitable physical interaction. The physical manipulation may also be a pattern or combination of physical interactions. An aspect of the physical manipulation may be a grip location such as one of several manipulation regions, grip pressure, button push, throw intensity, roll intensity, or shake intensity, rotation direction, rotation speed, linear speed, acceleration, throw or roll launch angle, throw or roll launch direction, throw or roll type (e.g., lob, side-arm, underhand, forehand, backhand, and overhand), orientation, position, start time, end time, and duration. The physical manipulation aspect may relate to any portion or another aspect of the physical manipulation such as a start of the physical manipulation and an end of the physical manipulation. For example, the physical manipulation aspect may be an orientation of the drone at the beginning of a roll or a rotation speed at the end or release point of a throw. Physical manipulation aspects may be relative to an internal reference frame of the drone such as a central vertical axis or a “front” of the drone or an external reference frame such as GPS coordinate system, compass directions, a user, a homing station or base, another drone, or any other suitable reference frame. For example, a position of the drone at the end of a throw may be relative to a thrower's body or a ground surface.

The processor may then select an action or modify an aspect of an action according to the sensed physical manipulation or physical manipulation aspect. For example, an action may be flying, hovering, diving, homing, rotating, turning, obtaining a payload, releasing a payload, or any other suitable action. The action may also be a pattern or combination of actions such as flying, releasing a payload, and homing. An aspect of the action may be a start delay, duration, intensity, speed, linear direction, velocity, rotational direction, and path. For example, a clockwise rotation direction of the drone may be selected for a backhand throw. As another example, a boomerang return path may be initiated after ten seconds for a slow throw or after twenty seconds for a fast throw.

The processor may then instruct the drone to perform the selected action. For example, the processor may increase an output of the motors such that the propellers elevate the drone upon completion of a throwing motion.

The processor may also change the action or alter an aspect of the action according to the physical manipulation or physical manipulation aspect. For example, the processor may guide the drone in a high arc if the throwing motion is a lob and the throw trajectory is a high angle. As another example, the processor may instruct the drone to fly in a circle if the drone was gripped in a first manipulation region, in a square if the drone was gripped in a second manipulation region, to a target point and back if the drone was gripped in a third manipulation region, and to a home base if the drone was gripped in a fourth manipulation region.

The processor may instruct the drone to perform a secondary action before, after, during, or instead of performance of the action. The secondary action may be a collision avoidance maneuver, a coordination maneuver, an objective, communication, or any other suitable secondary action. For example, the processor may instruct the drone to abort the action and hover if the camera or one of the sensors senses that the drone is too close to the ground, a wall, a tree, another drone, or any other obstacle. As another example, the processor may instruct the camera to capture an image or video recording once the drone reaches a predetermined height or target area.

The processor may select or modify an action, secondary action, or action aspect, or instruct the drone to perform an action or secondary action, or a pattern or combination of actions and secondary actions, only if a predetermined condition is met. For example, the processor may instruct the drone to complete a series of actions only if the manipulation regions were touched in a predetermined order to prevent unwanted or unauthorized users from operating the drone. As another example, the processor may instruct the drone to complete a series of actions only if the drone is receiving a GPS signal. Similarly, the processor may instruct the drone to perform a first set of actions for a given physical manipulation if the drone is indoors and a second set of actions for the same physical manipulation if the drone is outdoors.

The above-described drone and drone controlling method provide several advantages. For example, the drone can be intuitively controlled via physical manipulations of the drone. A user does not need to master conventional control inputs that often do not translate very well to actual drone behavior. Complex drone behavior can be initiated by a single physical manipulation instead of several inputs. The drone may partake in concerted multi-drone activity by communicating with other drones and avoiding collisions therebetween. To that end, a user can deploy a number of drones by enacting a physical manipulation on each drone in quick succession. The drone may perform additional tasks such as search and rescue by receiving additional physical manipulations. For example, the drone may determine that a missing person is alive by sensing the missing person grabbing or swatting it. Importantly, the missing person may not be in a condition to manipulate the drone via conventional inputs. The drone may then alert a search party to the missing person's location by transmitting GPS coordinates or by returning to the search party and then leading the search party to the missing person's location.

This summary is not intended to identify essential features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 is a top plan view of a drone constructed in accordance with an embodiment of the invention;

FIG. 2 is a schematic diagram of a control system of the drone of FIG. 1; and

FIG. 3 is a flow diagram of a method of controlling the drone of FIG. 1 in accordance with another embodiment of the invention.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment”, “an embodiment”, or “embodiments” mean that the feature or features referred to are included in at least one embodiment of the invention. Separate references to “one embodiment”, “an embodiment”, or “embodiments” in this description do not necessarily refer to the same embodiment and are not mutually exclusive unless so stated. Specifically, a feature, structure, act, etc. described in one embodiment may also be included in other embodiments, but is not necessarily included. Thus, particular configurations of the present invention can include a variety of combinations and/or integrations of the embodiments described herein.

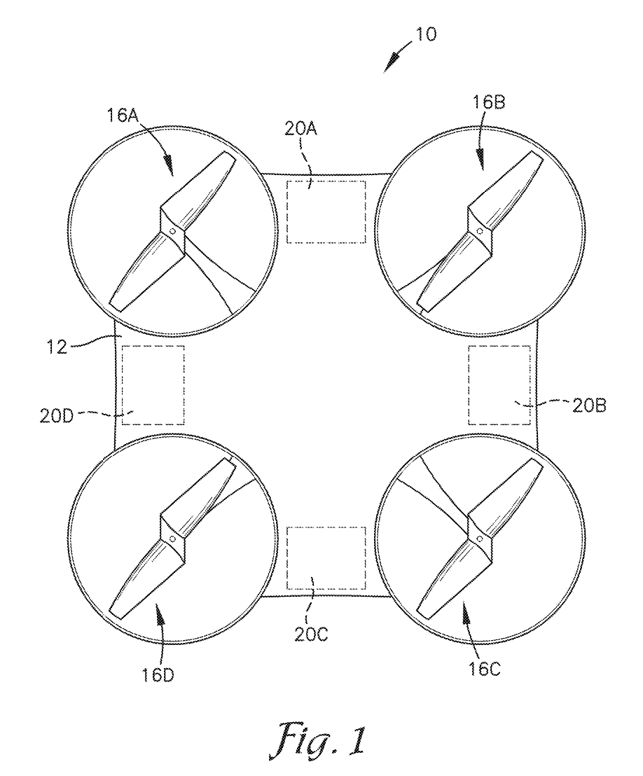

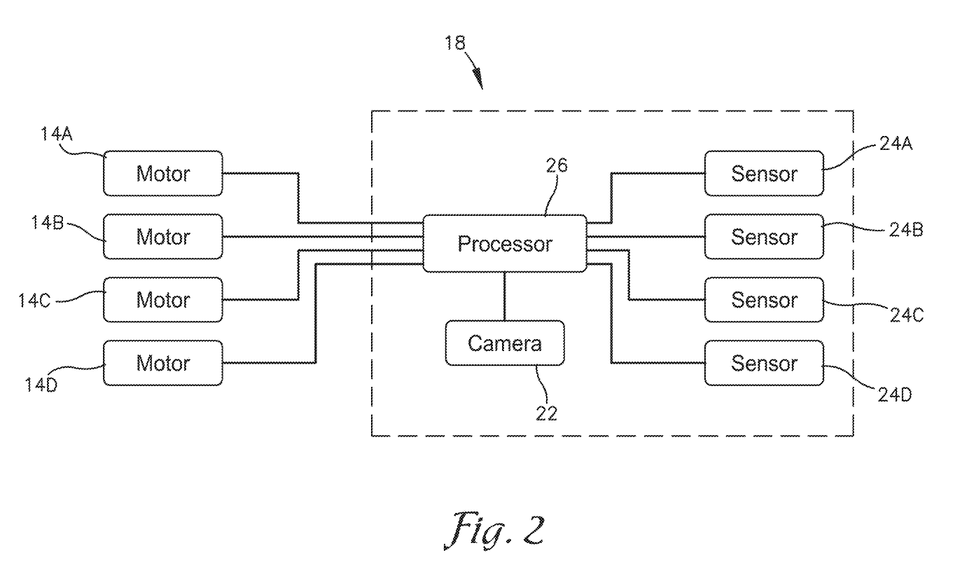

Turning to FIGS. 1 and 2, a drone 10 constructed in accordance with an embodiment of the present invention is illustrated. The drone 10 broadly comprises a frame 12, a plurality of motors 14A-D, a plurality of propellers 16A-D, and a control system 18. Other autonomous or semi-autonomous devices or vehicles such as robots, crawling devices, throwable devices, driving devices, digging devices, climbing devices, floating devices, submersible devices, and space-borne devices may be used.

The frame 12 supports the other components of the drone 10 and may include a plurality of manipulation regions 20A-D, propeller guards, landing gear or landing supports, payload holders, and other suitable structure. The manipulation regions 20A-D are designated areas on the frame that a user may grasp for manipulating the drone 10. The manipulation regions 20A-D may be located between the propellers 16A-D as shown or on any suitable and safe portion of the drone 10. Four manipulation regions 20A-D are depicted although any suitable number of manipulation regions may be used.

The motors 14A-D drive the propellers 16A-D and may be any suitable motion-generating components such as electric motors, actuators, and gas-powered engines. It will be understood that other propulsion systems such as rockets, jets, compressed gas expulsion systems, and maglev systems may be used. The motors 14A-D may be variable speed or single speed motors. Each motor 14A-D may drive one of the propellers 16A-D. Alternatively, a single motor may be used to drive all of the propellers 16A-D.

The propellers 16A-D (or rotors) thrust the drone 10 through the air under power from the motors 14A-D and may be fixed pitch propellers, variable pitch propellers, tiltrotors, or any other suitable propellers. As mentioned above, other propulsion systems such as rockets, jets, and compressed gas expulsion systems may be used.

The control system 18 controls the drone 10 and includes a camera 22, a plurality of sensors 24A-D, and a processor 26. The control system 18 may be incorporated entirely in the drone 10 itself or may include or may be in wired or wireless communication with external control or reference devices or systems such as handheld controllers, smartphones, remote computers, GPS satellites, homing bases, and other drones.

The camera 22 provides environmental feedback and may be a digital camera or video camera, infrared camera or sensor, proximity camera or sensor, radar or lidar transceiver, or any other suitable environmental sensor. The camera 22 may be stationary or controllable for increasing its sensing area and may be used for capturing images, video recordings, and other data.

The sensors 24A-D sense physical manipulation, or an aspect of the physical manipulation, of the drone 10, as described in more detail below, and may be positioned near the manipulation regions 20A-D. The sensors 24A-D may be or may include pressure sensors, accelerometers, a compass, motion sensors, proximity sensors, or any combination thereof.

The processor 26 interprets data from the camera 22 and sensors 24A-D and controls the drone 10 according to the interpreted data and other inputs, as described in more detail below. The processor 26 may include a circuit board, memory, and other electronic components such as a display and inputs for receiving external commands and a transmitter for transmitting data and electronic instructions.

The processor 26 may implement aspects of the present invention with one or more computer programs stored in or on computer-readable medium residing on or accessible by the processor. Each computer program preferably comprises an ordered listing of executable instructions for implementing logical functions and controlling the drone 10 according to physical manipulations and other inputs. Each computer program can be embodied in any non-transitory computer-readable medium, such as a memory (described below), for use by or in connection with an instruction execution system, apparatus, or device, such as a computer-based system, processor-containing system, or other system that can fetch the instructions from the instruction execution system, apparatus, or device, and execute the instructions.

The memory may be any computer-readable non-transitory medium that can store the program for use by or in connection with the instruction execution system, apparatus, or device. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

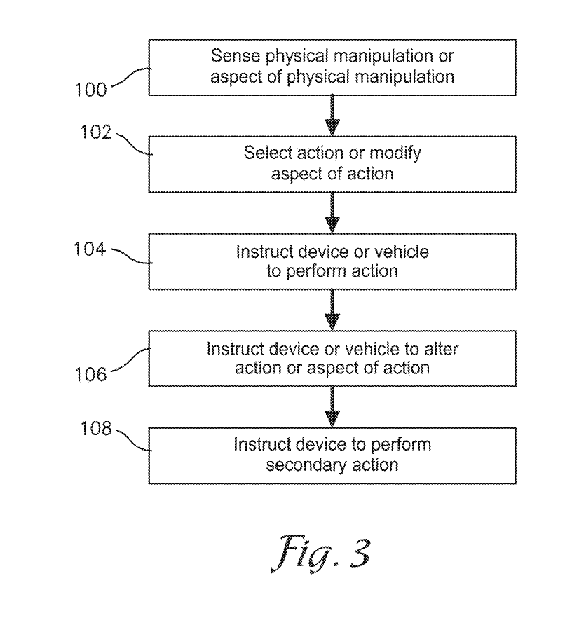

Turning to FIG. 3 and with reference to FIGS. 1 and 2, control of the drone 10 will now be described in detail. First, the camera 22 or one of the sensors 24A-D may sense a physical manipulation or an aspect of a physical manipulation of the drone 10, as shown in block 100. For example, the physical manipulation may be a grasp/grip, hold, shake, move, throw, toss, push, roll, or any other suitable interaction. The physical manipulation may also be a pattern or combination of interactions. An aspect of the physical manipulation may be a grip location (e.g., one of the manipulation regions 20A-D), grip pressure, button push, throw intensity, roll intensity, shake intensity, rotation direction, rotation speed, linear speed, acceleration, throw or roll launch angle, throw or roll launch direction, throw or roll type (e.g., lob, side-arm, underhand, forehand, backhand, and overhand), orientation, position, start time, end time, duration, or any other suitable physical manipulation aspect. The physical manipulation aspect may relate to any portion or another aspect of the physical manipulation such as a start of the physical manipulation and an end of the physical manipulation. For example, the physical manipulation aspect may be an orientation of the drone 10 at the beginning of a roll or a rotation speed at the end or release point of a throw. Physical manipulation aspects may be relative to an internal reference frame of the drone 10 such as a central vertical axis or a “front” of the drone 10 or an external reference frame such as GPS coordinate system, compass directions, a user, a homing station or base, another drone, or any other suitable reference frame. For example, a position of the drone 10 at the end of a throw may be relative to a thrower's body or a ground surface.

The processor 26 may then select an action or modify an aspect of an action according to the sensed physical manipulation or physical manipulation aspect, as shown in block 102. For example, an action may be flying, hovering, diving, homing, rotating, turning, obtaining a payload, releasing a payload, or any other suitable action. The action may also be a pattern or combination of actions such as flying, releasing a payload, and homing. An aspect of the action may be a start delay, duration, intensity, speed, linear direction, velocity, rotational direction, and path, or any other suitable action aspect. For example, a clockwise rotation direction of the drone 10 may be selected for a backhand throw. As another example, a boomerang return path may be implemented after ten seconds for a slow throw or after twenty seconds for a fast throw.

The processor 26 may then instruct the drone 10 to perform the selected action, as shown in block 104. For example, the processor 26 may increase an output of the motors 14A-D such that the propellers 16A-D elevate the drone 10 upon completion of a throwing motion.

The processor 26 may also change the action or alter an aspect of the action according to the physical manipulation or physical manipulation aspect, as shown in block 106. For example, the processor 26 may guide the drone 10 in a high arc if the throwing motion is a lob and the throw trajectory is a high angle. As another example, the processor 26 may instruct the drone 10 to fly in a circle if the drone 10 was gripped in the first manipulation region 20A, in a square if the drone was gripped in the second manipulation region 20B, to a target point and back if the drone 10 was gripped in the third manipulation region 20C, and to a home base if the drone 10 was gripped in the fourth manipulation region 20D.

The processor 26 may instruct the drone 10 to perform a secondary action before, after, during, or instead of performance of the action, as shown in block 208. The secondary action may be a collision avoidance maneuver, a coordination maneuver, an objective, communication, or any other suitable secondary action. For example, the processor 26 may instruct the drone 10 to abort the action and hover if the camera 22 or one of the sensors 24A-D senses that the drone 10 is too close to the ground, a wall, a tree, another drone, or any other obstacle. As another example, the processor 26 may instruct the camera 22 to take a picture or video once the drone 10 reaches a predetermined height or target area. As yet another example, the processor 26 may transmit GPS coordinates upon finding a missing person.

The processor 26 may select or modify an action, secondary action, or action aspect, or instruct the drone 10 to perform an action or secondary action, or a pattern or combination of actions and secondary actions, only if a predetermined condition is met. For example, the processor 26 may instruct the drone 10 to complete a series of actions only if the manipulation regions 20A-D were touched in a predetermined order to prevent unwanted or unauthorized users from operating the drone 10. As another example, the processor 26 may instruct the drone 10 to complete a series of actions only if the drone 10 is receiving a GPS signal. Similarly, the processor 26 may instruct the drone 10 to perform a first set of actions for a given physical manipulation if the drone 10 is indoors and a second set of actions for the same physical manipulation if the drone 10 is outdoors.

The above-described drone 10 and drone controlling method provide several advantages. For example, the drone 10 can be intuitively controlled via physical manipulations of the drone 10. A user does not need to master conventional control inputs that often do not translate very well to actual drone behavior. Complex drone behavior can be initiated by a single physical manipulation instead of several inputs. The drone 10 may partake in concerted multi-drone activity by communicating with other drones and avoiding collisions therebetween. To that end, a user can deploy a number of drones by enacting a physical manipulation on each drone in quick succession. The drone 10 may perform additional tasks such as search and rescue by receiving additional physical manipulations. For example, the drone 10 may determine that a missing person is alive by sensing the missing person grabbing or swatting it. Importantly, the missing person may not be in a condition to manipulate the drone 10 via conventional inputs. The drone 10 may then alert a search party to the missing person's location by transmitting GPS coordinates or returning to the search party and then leading the search party to the missing person's location.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A control system for controlling an autonomous or semi-autonomous device or vehicle, the control system comprising:
a sensor mounted on the autonomous or semi-autonomous device or vehicle, the sensor being configured to sense a physical manipulation or an aspect of the physical manipulation of the autonomous or semi-autonomous device; and
a processor in communication with the sensor, the processor being configured to:
select an action or modify an aspect of the action according to the sensed physical manipulation or physical manipulation aspect; and
instruct the autonomous or semi-autonomous device or vehicle to perform the action.

2. The control system of claim 1, wherein the physical manipulation is a throw, toss, push, or roll of the autonomous or semi-autonomous device or vehicle.

3. The control system of claim 2, wherein the sensor is a pressure sensor and the physical manipulation aspect is at least one of a grip location and a grip pressure during the throw or roll.

4. The control system of claim 2, wherein the sensor is an accelerometer or motion sensor and the physical manipulation aspect is at least one of a throw or roll intensity, a rotation direction, a rotation speed, a throw or roll launch angle, a throw or roll launch direction, and a throw or roll type.

5. The control system of claim 4, wherein the throw or roll launch direction is relative to compass directions, another object, or a GPS coordinate system.

6. The control system of claim 2, wherein the sensor is a proximity sensor and the physical manipulation aspect is a position of the autonomous or semi-autonomous device or vehicle at a release point of the throw or roll.

7. The control system of claim 2, wherein the sensor includes a plurality of sensors comprising a pressure sensor, an accelerometer, and a proximity sensor, the physical manipulation aspect including a plurality of physical manipulation aspects including a) at least one of a grip location and a grip pressure during the throw, toss, push, or roll; b) at least one of a throw, toss, push, or roll intensity, a rotation direction, a rotation speed, a throw, toss, push, or roll launch angle, and a throw, toss, push, or roll type; and c) a position of the autonomous or semi-autonomous device or vehicle at a release point of the throw, toss, push, or roll, the action or an aspect of the action being determined based on a combination of values of a), b), and c).

8. The control system of claim 1, wherein the action is at least one of flying, hovering, diving, homing, rotating, turning, rolling, obtaining a payload, and releasing a payload.

9. The control system of claim 1, wherein the action is a pattern, combination, or sequence of flying, hovering, diving, rolling, homing, rotating, turning, obtaining a payload, and releasing a payload.

10. The control system of claim 1, wherein the action aspect is at least one of a start delay, duration, intensity, speed, linear direction, rotational direction, and path.

11. The control system of claim 1, wherein the processor is configured to select or modify the action and instruct the autonomous or semi-autonomous device or vehicle to perform the action only if a predetermined condition is met.

12. The control system of claim 1, wherein the processor is further configured to instruct the autonomous or semi-autonomous device or vehicle to avoid colliding with other autonomous or semi-autonomous devices or vehicles.

13. The control system of claim 1, wherein the processor is further configured to adjust motion of the autonomous or semi-autonomous device or vehicle after the physical manipulation has ended according to at least one of orientation, spin, position, and velocity of the autonomous or semi-autonomous device so that the autonomous or semi-autonomous device or vehicle follows a desired path or pattern without further user input.

14. A method of controlling an autonomous or semi-autonomous device or vehicle, the method comprising the steps of:
sensing a physical manipulation or an aspect of the physical manipulation of the autonomous or semi-autonomous device via a sensor mounted on the autonomous or semi-autonomous device or vehicle;
selecting an action or modifying an aspect of the action according to the sensed physical manipulation or physical manipulation aspect; and
instructing the autonomous or semi-autonomous device or vehicle to perform the action.

15. The method of claim 14, wherein the physical manipulation is a throw, toss, push, or roll of the autonomous or semi-autonomous device or vehicle.

16. The method of claim 15, wherein the sensor is a pressure sensor and the physical manipulation aspect is at least one of a grip location and a grip pressure during the throw or roll.

17. The method of claim 15, wherein the sensor is an accelerometer or motion sensor and the physical manipulation aspect is at least one of a throw or roll intensity, a rotation direction, a rotation speed, a throw or roll launch angle, a throw or roll launch direction, and a throw or roll type.

18. The method of claim 17, wherein the throw or roll launch direction is relative to compass directions, another object, or a pre-selected directional framework.

19. The method of claim 15, wherein the sensor is a proximity sensor and the physical manipulation aspect is a position of the autonomous or semi-autonomous device or vehicle at a release point of the throw or roll.

20. The method of claim 15, wherein the sensor includes a plurality of sensors comprising a pressure sensor, an accelerometer, and a proximity sensor, the physical manipulation aspect including a plurality of physical manipulation aspects including a) at least one of a grip location and a grip pressure during the throw, toss, push, or roll; b) at least one of a throw, toss, push, or roll intensity, a rotation direction, a rotation speed, a throw, toss, push, or roll launch angle, and a throw, toss, push, or roll type; and c) a position of the autonomous or semi-autonomous device or vehicle at a release point of the throw, toss, push, or roll, the action or an aspect of the action being determined based on a combination of values of a), b), and c).

21. The method of claim 14, wherein the action is at least one of flying, hovering, diving, homing, rotating, turning, rolling, obtaining a payload, and releasing a payload.

22. The method of claim 14, wherein the action is a pattern, combination, or sequence of flying, hovering, diving, rolling, homing, rotating, turning, obtaining a payload, and releasing a payload.

23. The method of claim 14, wherein the action aspect is at least one of a start delay, duration, intensity, speed, linear direction, rotational direction, and path.

24. The method of claim 14, wherein the steps of selecting the action or modifying the action aspect and instructing the autonomous or semi-autonomous device or vehicle to perform the action is performed only if a predetermined condition is met.

25. The method of claim 14, further comprising the step of instructing the autonomous or semi-autonomous device or vehicle to avoid colliding with other autonomous or semi-autonomous devices or vehicles.

26. The method of claim 14, further comprising the step of adjusting motion of the autonomous or semi-autonomous device or vehicle after the physical manipulation has ended according to at least one of orientation, spin, position, and velocity of the autonomous or semi-autonomous device or vehicle so that the autonomous or semi-autonomous device or vehicle follows a desired path or pattern without further user input.
